(19) United States
(12) Patent Application Publication
(10) Pub. No.: US 2005/0027530 A1
(43) Pub. Date: Feb. 3, 2005

(54) Audio-visual speaker identification using coupled hidden markov models

(76) Inventors: Tieyan Fu, Beijing (CN); Xiaoxing Liu, Beijing (CN); Luhong Liang, Beijing (CN); Xiaobo Pi, Beijing (CN); Ara Victor Nefian, Santa Clara, CA (US)

Correspondence Address: Timothy N. Trop;TROP, PRUNER & HU, P.C., STE 100, 8554 KATY FWY, HOUSTON, TX, 77024-1841, US

(21) Appl. No.: 10/631,424

(22) Filed: Jul. 31, 2003

(51) Int. Cl. G10L 15/14

(52) U.S. Cl. 704/256

(57) ABSTRACT

A phoneme and a viseme of a person may be modeled using a coupled hidden Markov model. The coupled hidden Markov model and a second model may be compared to identify the person.

### BACKGROUND

This invention relates generally to speaker identification using statistical modeling.

Statistical modeling has been used to recognize speech for decades. Initially, only audio information was used, and visual information was disregarded. However, this technique left speech recognition systems susceptible to acoustic noise, which is encountered in most real-world applications.

Advancements in statistical modeling techniques lead to audio-visual speech recognition (“AVSR”) systems, which are capable of incorporating visual information with audio information to provide more robust and accurate systems. Visual information generally cannot be corrupted by acoustic noise. A system may extract a sequence of visual features from a person's mouth shape over time and combine the sequence with features of the person's acoustic speech using statistical modeling techniques. The strong correlation between acoustic and visual speech is well known in the art.

Recently, attempts have been made to use statistical modeling of audio and visual features not only to recognize speech, but also to identify a speaker. Speaker identification systems that utilize both audio and visual features may be broadly grouped into two categories: feature fusion systems and decision level fusion systems. In feature fusion systems, the observation vectors are obtained by combining audio and visual features together. A statistical analysis may be performed on these observation vectors to identify the speaker. However, feature fusion systems cannot describe the audio and visual asynchrony of natural speech.

A decision level fusion system may determine the accuracy with which a visual feature or an audio feature may be recognized. The determination may be made independently for the visual feature and the audio feature. The decision level fusion system may utilize the determination of the accuracy with which the visual feature and the audio feature may be recognized to facilitate identification of a speaker. However, decision level fusion systems often fail to entirely capture dependencies between the audio and visual features.

Thus, there is a need for an improved way of identifying a speaker using statistical modeling.

### BRIEF DESCRIPTION OF THE DRAWINGS

FIG. 1 is a system according to an embodiment of the present invention;

FIG. 2 is a face detection region and an estimated region of search for a mouth according to an embodiment of the present invention;

FIG. 3 is an enlarged view of the estimated region of search for the mouth shown in FIG. 2 according to an embodiment of the present invention;

FIG. 4 is a mouth detection region according to an embodiment of the present invention;

FIG. 5 is a flow chart for software that may be utilized by the system shown in FIG. 1 according to an embodiment of the present invention; and

FIG. 6 is a state diagram of a coupled hidden Markov model that may be utilized by the system shown in FIG. 1 according to an embodiment of the present invention.

### DETAILED DESCRIPTION

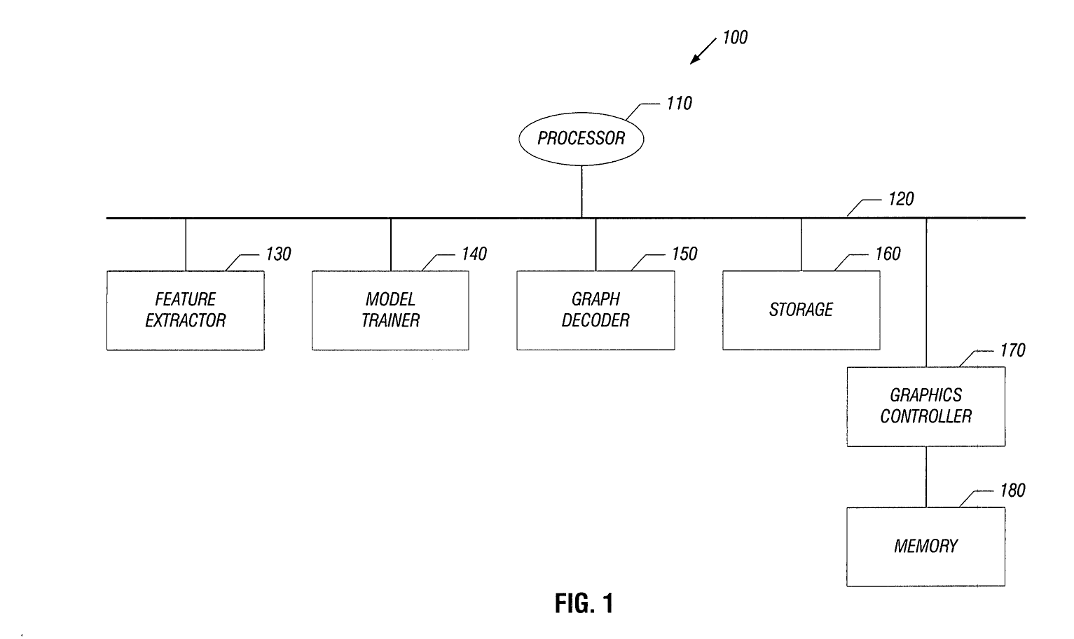

Referring to FIG. 1, a system 100 may be any processor-based system, including a desktop computer, a laptop computer, a hand held computer, a cellular telephone, or a computer network, to mention a few examples. The system 100 may include a processor 110 coupled over a bus 120, in some embodiments, to a feature extractor 130, a model trainer 140, a graph decoder 150, a storage 160, and a graphics controller 170. The feature extractor 130, the model trainer 140, and/or the graph decoder 150 may be hardware or software. For example, the software may be stored in the storage 160. For example, the feature extractor 130, the model trainer 140, or the graph decoder 150 may be a semiconductor chip, such as a specialized processor in some embodiments. In some embodiments, the feature extractor 130, the model trainer 140, and/or the graph decoder 150 may be implemented on the processor 110. In some embodiments, the processor 110 and the feature extractor 130 may be a unitary component. In some embodiments, the processor 110 and the model trainer 140 may be a unitary component. In some embodiments, the processor 110 and the graph decoder 150 may be a unitary component.

The feature extractor 130 may determine a set of acoustic and visual features that describe a phoeneme or a viseme respectively. A viseme may represent a unit of visual speech. For example, when a speaker pronounces the word “see”, the positioning of the mouth as the speaker pronounces the letter “s” may be detected as a viseme. The viseme may be included in a visual data stream or a temporal sequence of visual observations obtained from the shape of the speaker's mouth, for example.

A phoneme is a unit of sound. For example, the sound produced by the speaker as the speaker pronounces the letter “s” may be detected as a phoneme. The phoneme may be included in an audio data stream or a temporal sequence of audio observations obtained from the acoustic speech of the speaker, for example.

The model trainer 140 may model the phoneme and the viseme of the speaker using a coupled hidden Markov model (“CHMM”). A CHMM may be defined as at least two hidden Markov models (“HMMs”) in which a state of one HMM of the CHMM is conditionally dependent upon a state of another HMM of the CHMM.

A CHMM may include one HMM for each data stream in one embodiment. For example, the model trainer 140 may receive visual data and audio data. The CHMM in this example may include a HMM for the visual data and another HMM for the audio data. In this example, the CHMM may be described as having two channels, one for audio observations and the other for visual observations. In some embodiments, the CHMM may be capable of describing the natural audio and visual state asynchrony and their conditional dependency over time.

In some embodiments, parameters may be used to describe conditional dependencies between states of HMMs of a CHMM. For example, in some embodiments, parameters of a CHMM having an audio channel and a visual channel may be defined as follows:

$$\begin{matrix}{π}_{o}^{c} ( i ) = P ( {q}_{l}^{c} = i ) \\ {b}_{t}^{c} ( i ) = P ( {O}_{t}^{c} \vert {q}_{t}^{c} = i ) \\ {a}_{i \vert j , k}^{c} = P ( {q}_{t}^{c} = i \vert {q}_{t - 1}^{a} = j , {q}_{t - 1}^{v} = k )\end{matrix}$$

where c ε {a, v} may denote the audio and visual channels respectively, Oₜ^{c} may be an observation vector of time t corresponding to channel c, and qₜ^{c}, may be a state in the cth channel of the CHMM at time t. A state may describe a cluster of observation vectors. The state is generally a discrete value, such as 1, 2, or 3. πₒ^{c}(i) may be defined as the probability that a state in the cth channel of the CHMM at time, t=1, may equal a value, i. bₜ^{c}(i) may be defined as the probability at time, t, that an observation vector may occur, provided a state in the cth channel of the CHMM at time, t, equals the value, i. a_{i|j,k}^{c} may be defined as the probability that a state in the cth channel of the CHMM at time, t, may equal a value, i, provided that a state in the audio channel at time, t−1, equals a value,j, and a state in the visual channel at time, t−1, equals a value, k. For example, the conditional dependency between audio and visual states of the CHMM, as described with respect to parameter a_{i|j,k}^{c}, may indicate that the HMM for the visual data and the HMM for the audio data are coupled.

A state of a CHMM may be modeled using a Gaussian density function, for example. In some embodiments, a weighted sum or mixture of Gaussian density functions may be used. For instance, a mixture of Gaussian density functions may be used to describe variations of audio and/or visual data. In a mixture of Gaussian density functions, some functions may affect the model of the state more than others. A mixture weight may indicate the proportional contribution of a particular density function to the model of the state.

For a model with mixtures of Gaussian density functions, the probability of an observation vector, given a particular state of the CHMM, may be described by the following equation in some embodiments:

$${b}_{t}^{c} ( i ) = {\sum }_{m = 1}^{{M}_{l}^{c}} {w}_{i , m ,}^{c} N ( {O}_{t}^{c} , {μ}_{i , m}^{c} {U}_{i , m}^{c} )$$

where μ_{i,m}^{c}, U_{i,m}^{c} and w_{i,m}^{c} may be a mean matrix, a covariance matrix, and a mixture weight, respectively, corresponding to an ith state, an mth mixture, and a cth channel of the CHMM. Mᵢ^{c} may be a number of mixtures corresponding to the ith state in the cth channel of the CHMM.

In some embodiments, training the CHMM parameters to identify a speaker may be performed in two stages. For example, in the first stage, a speaker-independent background model (“BM”) may be obtained for each CHMM corresponding to a viseme-phoneme pair. For example, in the second stage, the CHMM parameters may be adapted to a speaker-specific model. In some embodiments, the CHMM parameters may be adapted using a maximum a posteriori (“MAP”) method. In some embodiments, a CHMM may be trained to model silence between consecutive words using a CHMM. In some embodiments, a CHMM may be trained to model silence between consecutive sentences using a CHMM.

A BM may be trained using maximum likelihood training, for example. A CHMM may be initialized using a Viterbi-based method and/or an estimation-maximization (“EM”) algorithm, for example. In some embodiments, the CHMM parameters may be refined by using audio-visual speech to train the CHMM. In some embodiments, continuous audio-visual speech may be used to refine the CHMM parameters. In some embodiments, a mean matrix, a covariance matrix, and a mixture weight of the BM may be represented as (μ_{i,m}^{c})_{BM}, (U_{i,m}^{c})_{BM} and (w_{i,m}^{c})_{BM}, respectively.

In some embodiments, the state parameters of the background model may be adapted to characteristics associated with phonemes and visemes a speaker in a database, for example. In some embodiments, the database may be stored in a storage 160. The storage 160 may be a random access memory (“RAM”), a read only memory (“ROM”), or a flash memory, to give some examples. The state parameters may be adapted using Bayesian adaptation, for example. In some embodiments, the state parameters for a CHMM after adaptation occurs may be represented as \hat{μ}_{i,m}^{c}, Û_{i,m}^{c} and ŵ_{i,m}^{c}:
\hat{μ}_{i,m}^{c}=θ_{i,m}^{c}μ_{i,m}^{c}+(1−θ_{i,m}^{c})(μ_{i,m}^{c})BM (1)
\hat{U}_{i,m}^{c}=θ_{i,m}^{c}U_{i,m}^{c}−(μ_{i,m}^{c})²+(μ_{i,m}^{c})_{BM}²+(1−θ_{i,m}^{c})(U_{i,m}^{c})BM
\hat{w}_{i,m}^{c}=θ_{i,m}^{c}w_{i,m}^{c}+(1−θ_{i,m}^{c})(w_{i,m}^{c})BM (2)
where θ_{i,m}^{c} may be a parameter that controls MAP adaptation, for example, for mixture component m in channel c and state i, and the “\hat{ }” above the variables may indicate that adaptation has occurred. The state parameters may be calculated using the processor 110 or the model trainer 140, to give some examples. In some embodiments, statistics of the CHMM states corresponding to a specific speaker, μ_{i,m}^{c}, U_{i,m}^{c} and w_{i,m}^{c}, may be obtained using an EM algorithm from speaker-dependent data as follows:

$${μ}_{i , m}^{c} = \frac{{\sum }_{r , t} {γ}_{r , t}^{c} ( i , m ) {O}_{r , t}}{{\sum }_{r , t} {γ}_{r , t}^{c} ( i , m )}$$

$${μ}_{i , m}^{c} = \frac{{\sum }_{r , t} {γ}_{r , t}^{c} ( i , m ) ( {O}_{r , t}^{c} - {μ}_{i , m}^{c} ) {( {O}_{r , t}^{c} - {μ}_{i , m}^{c} )}^{T}}{{\sum }_{r , t} {γ}_{r , t}^{c} ( i , m )}$$

$${w}_{i , m}^{c} = \frac{{\sum }_{r , t} {γ}_{r , t}^{c} ( i , m )}{{\sum }_{r , t} {\sum }_{k} {γ}_{r , t}^{c} ( i , k )}$$

$$where$$

$${γ}_{r , t}^{c} ( i , m ) = \frac{{\sum }_{j} \frac{1}{{P}_{r}} {α}_{r , t} ( i , j ) {β}_{r , t} ( i , j )}{{\sum }_{i , j} \frac{1}{{P}_{r}} {α}_{r , t} ( i , j ) {β}_{r , t} ( i , j )} \frac{{w}_{i , m}^{c} N ( {O}_{r , t}^{c} \vert {μ}_{i , m}^{c} , {U}_{i , m}^{c} )}{{\sum }_{k} {w}_{i , k}^{c} N ( {O}_{r , t}^{c} \vert {μ}_{i , k}^{c} , {U}_{i , k}^{c} )} .$$

In some embodiments, α_{r,t}(i,j)=P(O_{r,1}, . . . , O_{r,t}|q_{r,t}^{a}=i,q_{r,t}^{v}=j) and β_{r,t}(i,j=P(O_{r,t+1}, . . . , O_{r,Tr}|q_{r,t}^{a}=i,q_{r,t}^{v}=j) may be forward and backward variables, respectively, computed for the r^{th} observation sequences O_{r,t}=[(O_{r,t}^{a})^{T},(O_{r,t}^{v})^{T}]^{T}, where Tᵣ may be the length of the r^{th} sequences and T may indicate the transpose of a vector. The forward and backward variables may provide a relationship between the CHMM parameters and observation features that may be detected, for example.

In some embodiments, an adaptation coefficient, which may control MAP adaptation, for example, may be defined as

$${θ}_{i , m}^{c} = \frac{{\sum }_{r , t} {γ}_{r , t}^{c} ( i , m )}{{\sum }_{r , t} {γ}_{r , t}^{c} ( i , m ) + δ}$$

where δ may be a relevance factor. The relevance factor may indicate the impact that the amount of data collected may have on the adaptation coefficient. For instance, as more data is collected, θ_{i,m}^{c} nears 1.0. For instance, if no data is collected, θ_{i,m}^{c}=1/δ. In some embodiments, as more speaker-dependent data for a mixture m of state i and channel c becomes available, the contribution of the speaker-specific statistics to the MAP state parameters may increase (see equations 1-2). On the other hand, when less speaker-specific data is available, the value of the MAP parameters may be closer to the values of the background model parameters.

The graph decoder in 150 computes the likelihood of a test sequence of audio-visual observations given the sequence of phoeneme-viseme pairs for each speaker in the database. The sequence of phoeneme-viseme pairs is known for a text dependent system. In some embodiments, the storage 160 may store the models of the people.

In some embodiments, a person whose model has the highest likelihood of matching the CHMM of the speaker may be identified as the speaker. The relative reliability of audio and visual features at different levels of acoustic noise may vary in some cases. In some embodiments, the observation probabilities may be modified, such that \tilde{b}ₜ^{c}(i)=[bₜ^{c}]^{λc}, c ε {a, v} where the audio and visual stream exponents, λₐ and λᵥ, may satisfy the following conditions: λₐ, λᵥ≧0 and λₐ+λᵥ=1.

The values of the audio and visual stream exponents, λₐ and λᵥ, may indicate the extent to which audio and visual features are to affect identification of a speaker. For example, in some embodiments, if audio features are to be ignored or if audio features are not extracted, λᵥ may equal 1.0, and λₐ may equal 0.0. For example, in some embodiments, if visual features are to be ignored or if visual features are not extracted, λᵥ may equal 0.0, and λₐ may equal 1.0.

The values of the audio and visual stream exponents, λₐ, and λᵥ, corresponding to a specific acoustic signal-to-noise ratio (“SNR”) may be obtained to reduce a speaker identification error rate, for example. The speaker identification error rate may be the frequency with which a speaker is incorrectly identified by the system 100, for example. For instance, assuming the acoustic SNR=30 db, λₐ=0.3, and λᵥ=0.7, a speaker identification error rate may be 1.2%, for example. Changing the stream exponents to λₐ=0.7 and λᵥ=0.3 may provide a speaker identification error rate of 0.0%, for example.

The graphics controller 170 may be coupled to the processor 110 to receive data from the processor 110. “Coupled” may be defined to mean directly or indirectly coupled. For example, the graphics controller 170 may be directly coupled to the processor 110 because no other device is coupled between the graphics controller 170 and the processor 110. For example, the graphics controller 170 may be indirectly coupled to the processor 110 because one or more devices are coupled between the graphics controller 170 and the processor 110. For instance, the graphics controller 170 may be coupled to another device, and the other device may be coupled to the processor 110.

In some embodiments, the graphics controller 170 may serve as an interface between the processor 110 and a memory 180. In some embodiments, the graphics controller 170 may perform logical operations on data in response to receiving the data from the memory 180 or the bus 120. For example, a logical operation may include comparing colors associated with the received data and colors associated with stored data. A logical operation may include masking individual bits of the received data, for instance. In some embodiments, the memory 180 may store data that is received by the graphics controller 170. For example, the memory 180 may store visual information associated with a speaker.

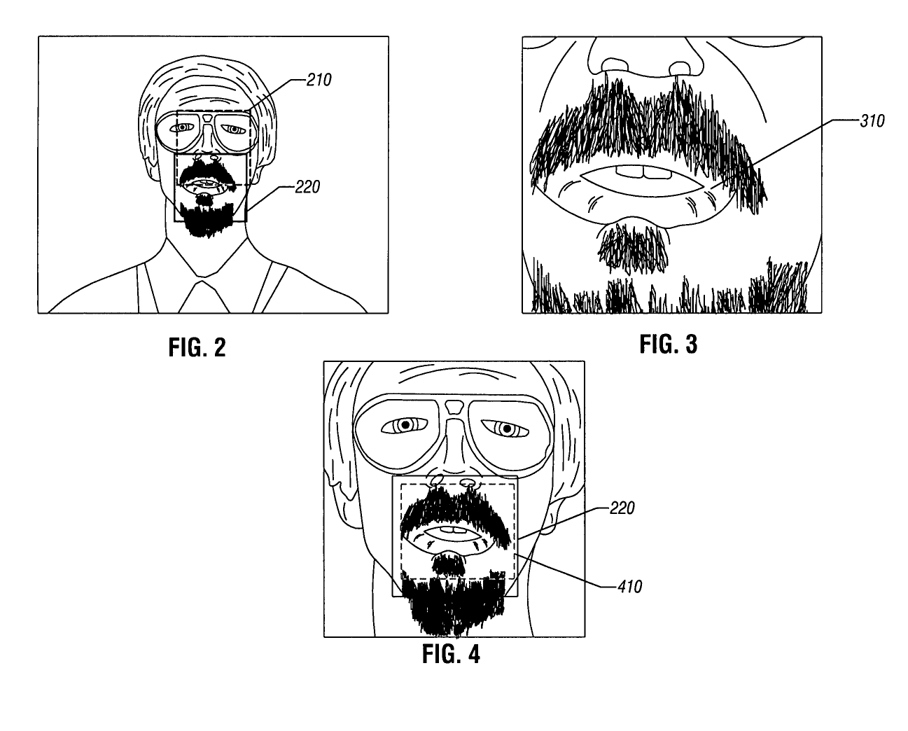

Referring to FIG. 2, the face of the speaker may be located before a viseme may be described. For example, the positioning of a mouth on a human face may be estimated to be within a particular region of the face. In some embodiments, the system 100 shown in FIG. 1 may determine a face detection region 210. In some embodiments, the system 100 may determine an estimated region of search for a mouth 220, based on the face detection region 210.

FIG. 3 is an enlarged view of the estimated region of search for the mouth 220 shown in FIG. 2. An analysis may be performed with respect to the estimated region of search for the mouth 220 to more accurately determine the location of the mouth 310 on the face of the speaker. In some embodiments, the system 100 may search for a shape within the estimated region 220, such as the shape of a football.

Referring to FIG. 4, a mouth detection region 410 may be determined within the estimated region 220. However, it is not necessary that the mouth detection region 410 be within the estimated region 220. For example, the mouth detection region 410 may lie partially within the estimated region 220 and extend outside the estimated region 220.

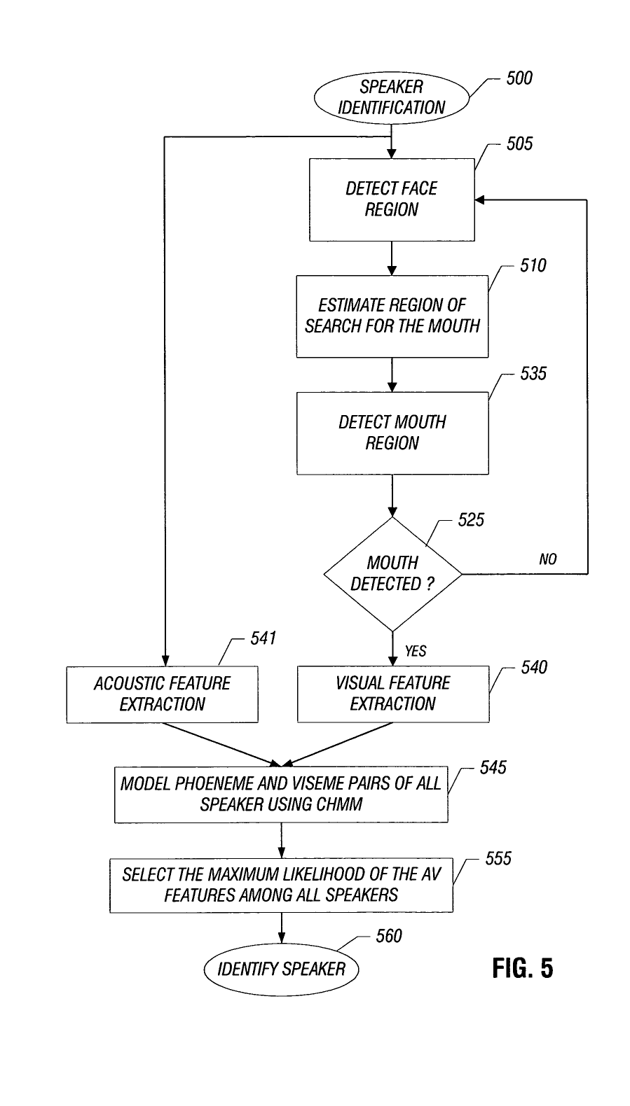

Referring to FIG. 5, speaker identification software 500, in one embodiment, may determine a face region at block 505. In some embodiments, the face region may be detected using a neural network. An estimated region of search for a mouth, on the lower region of the face, may be determined at block 510.

In some embodiments, the mouth region may be determined at block 535 using support vector machine classifiers. For example, the support vector machine classifiers may be stored in the memory 180 or the storage 160 (see FIG. 1).

If the speaker's mouth is not detected, as determined at diamond 525, a decision may be made whether to re-determine the face detection region at block 505. If the mouth is detected the system proceeds with the extraction of visual features. In some embodiments, the visual features at block 540 may be obtained from the mouth detection region via a cascade algorithm.

If the speaker's mouth is not detected, as determined at diamond 525, a decision may be made at diamond 525 whether to re-determine the face detection region at block 505.

If the mouth is detected, as determined at diamond 525, the mouth detection region may be mapped to a feature space. For example, the feature space may be a 32-dimensional feature space. In some embodiments, the mouth detection region may be mapped using a principal component analysis. For example, groups of 15 consecutive visual observation vectors may be concatenated and projected onto a linear discriminant space. In some embodiments, if the vectors are projected onto a 13 class, linear discriminant space, for instance, the resulting audio and visual observation vectors may each have 13 elements or features. In some embodiments, first and second order time derivatives of the visual observation vector may be used as visual observation sequences to be modeled using a CHMM. In this example, using the first and second time derivatives may result in a visual observation vector having 39 elements: 13 elements from each of the original visual observation vector, the first derivative, and the second derivative.

The acoustic features are determined at block 541, and consist of 13 Mel frequency cepstral coefficients, and their first and second order derivatives.

A test audio-visual sequence of observation vectors may be modeled at block 545 using a set of CHMM, one for each pair of phoeneme-visemes and for each speaker in the database. The highest likelihood of the audio visual test sequence given all speakers in the database is obtained in block 555 and reveals the identity of the speaker for which the test sequence was captured.

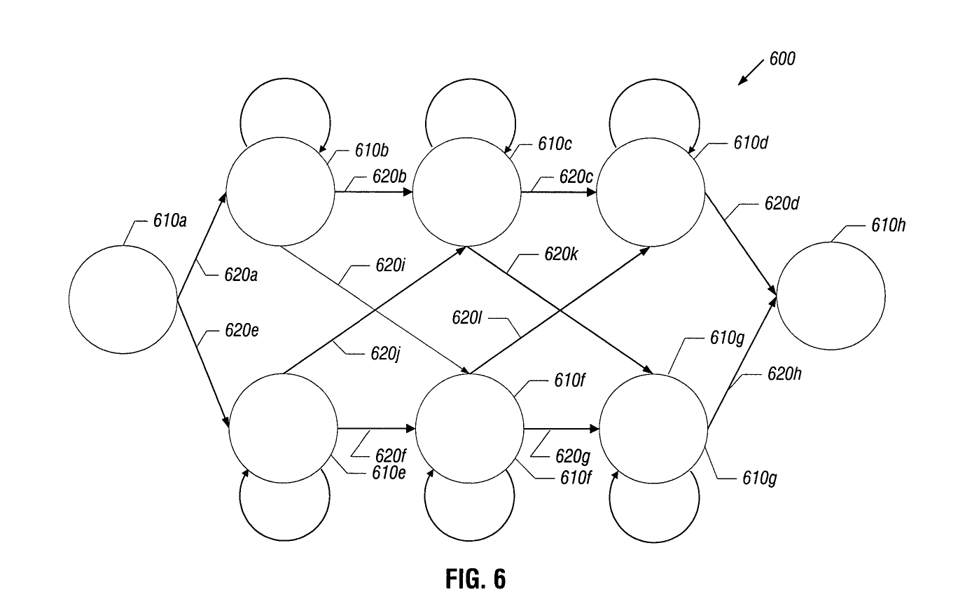

Referring to FIG. 6, a state diagram 600 may indicate the relation between states 610 of a CHMM. The state diagram 600 may include states 610 to describe audio and/or visual observations. In FIG. 6, audio observations may be described by states 610b-d, and visual observations may be described by states 610e-g. Arrows 620 of the state diagram 600 indicate probabilistic conditional dependency between states 610. For example, the conditional probability that data assigned to audio state 610c and visual state 610f at time t is assigned to audio state 610d at time t+1 may be non-zero, because an arrow 620 extends from audio state 610c to audio state 610d and an arrow 620 extends from visual state 610f to audio state 610d. For example, the conditional probability that data assigned to audio state 610c and visual state 610e at time t is assigned to audio state 610d at time t+1 may be zero, because although an arrow 620 extends from audio state 610c to audio state 610d, an arrow 620 does not extend from visual state 610e to audio state 610d.

In this example, data need not be temporally aligned between the audio states 610b-d and the visual states 610e-g. For instance, data may be temporally aligned if the data is assigned to audio state 610b and visual state 610e, or audio state 610c and visual state 610f, or audio state 610d and visual state 610g. In some embodiments, data may be assigned to any one of the audio states 610b-d and any one of the visual states 610e-g.

A non-emitting state may be a state that is not associated with an observation. In some embodiments, an entry non-emitting state 610a and/or an exit non-emitting state 610h may be included in the CHMM to facilitate phoneme-viseme synchrony at the boundaries of the CHMM, for example. For instance, while data may not be temporally aligned between the audio states 610b-d and the visual states 610e-g, data may be temporally aligned at the non-emitting states 610a, h. In some embodiments, the non-emitting states 610a, 610h may be used to concatenate or combine models.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
modeling a phoneme and a viseme of a person using a coupled hidden Markov model; and
comparing the coupled hidden Markov model and a second model to identify the person.

2. The method of claim 1 including utilizing a speaker-independent model having parameters and adapting the parameters to a speaker-dependent model.

3. The method of claim 2 wherein utilizing the speaker-independent model includes using estimation-maximization, and adapting the parameters includes using a maximum a posteriori method.

4. The method of claim 1 further including identifying the person based on a likelihood that the coupled hidden Markov model matches the second model.

5. The method of claim 1 further including modeling silence between consecutive words using a coupled hidden Markov model.

6. The method of claim 1 further including modeling silence between consecutive sentences using a coupled hidden Markov model.

7. An article comprising a medium storing instructions that, if executed, enable a processor-based system to:
model a phoneme and a viseme of a person using a coupled hidden Markov model; and
compare the coupled hidden Markov model and a second model to identify the person.

8. The article of claim 7 further storing instructions that, if executed, enable the system to utilize a speaker-independent model having parameters and to adapt the parameters to a speaker-dependent model.

9. The article of claim 7 further storing instructions that, if executed, enable the system to utilize a speaker-independent model using estimation-maximization and to adapt the parameters to a speaker-dependent model using a maximum a posteriori method.

10. The article of claim 7 further storing instructions that, if executed, enable the system to identify the person based on a likelihood that the coupled hidden Markov model matches the second model.

11. The article of claim 7 further storing instructions that, if executed, enable the system to model silence between consecutive words using a coupled hidden Markov model.

12. The article of claim 7 further storing instructions that, if executed, enable the system to model silence between consecutive sentences using a coupled hidden Markov model.

13. An apparatus comprising:
a model trainer to model a phoneme and a viseme of a person using a coupled hidden Markov model; and
a graph decoder to compare the coupled hidden Markov model and a second model to identify the person.

14. The apparatus of claim 13 further including a feature extractor to detect the viseme of the person.

15. The apparatus of claim 13 including the model trainer to utilize a speaker-independent model having parameters and to adapt the parameters to a speaker-dependent model.

16. The apparatus of claim 13 including the model trainer to utilize a speaker-independent model using estimation-maximization and to adapt the parameters to a speaker-dependent model using a maximum a posteriori method.

17. The apparatus of claim 13 including the graph decoder to identify the person based on a likelihood that the coupled hidden Markov model matches the second model.

18. The apparatus of claim 13 including the model trainer to model silence between consecutive words using a coupled hidden Markov model.

19. The apparatus of claim 13 including the model trainer to model silence between consecutive sentences using a coupled hidden Markov model.

20. A system comprising:
a processor-based device;
a graphics controller coupled to the processor-based device to receive data from the processor-based device; and
a storage coupled to the processor-based device storing instructions that, if executed, enable the processor-based device to:
model a phoneme and a viseme of a person using a coupled hidden Markov model, and
compare the coupled hidden Markov model and a second model to identify the person.

21. The system of claim 20 further storing instructions that, if executed, enable the processor-based device to utilize a speaker-independent model having parameters and to adapt the parameters to a speaker-dependent model.

22. The system of claim 20 further storing instructions that, if executed, enable the processor-based device to utilize a speaker-independent model using estimation-maximization and to adapt the parameters to a speaker-dependent model using a maximum a posteriori method.

23. The system of claim 20 further storing instructions that, if executed, enable the processor-based device to identify the person based on a likelihood that the coupled hidden Markov model matches the second model.

24. The system of claim 20 further storing instructions that, if executed, enable the processor-based device to model silence between consecutive words using a coupled hidden Markov model.

25. The system of claim 20 further storing instructions that, if executed, enable the processor-based device to model silence between consecutive sentences using a coupled hidden Markov model.
